(19) United States
(12) Patent Application Publication
(10) Pub. No.: US 2025/0326093 A1
(43) Pub. Date: Oct. 23, 2025

(54) RATCHET WITH SWIVEL HEAD

(71) Applicant: MILWAUKEE ELECTRIC TOOL CORPORATION, Brookfield, WI (US)

(72) Inventor: Kyle A. Marten, Plymouth, WI (US)

(21) Appl. No.: 19/184,791

(22) Filed: Apr. 21, 2025

Related U.S. Application Data
(60) Provisional application No. 63/636,535, filed on Apr. 19, 2024.

(51) Int. Cl. B25B 23/00; B25B 13/46; B25B 13/48

(52) U.S. Cl. CPC B25B 23/0014; B25B 13/463; B25B 23/0035; B25B 13/481

(57) ABSTRACT

A ratchet may include a ratchet head and a drive assembly supported by the ratchet head. The drive assembly includes a yoke rotationally supported in the ratchet head, a spline rotationally supported in the yoke. The spline is rotatable about a spline rotation axis, and an anvil is at least partially supported in the spline. The anvil is rotatable with the spline, the anvil having an anvil rotation axis, the anvil rotation axis positionable at an angle relative to the spline rotation axis.

### CROSS-REFERENCE TO RELATED APPLICATIONS

This application claims priority to co-pending U.S. Provisional Application No. 63/636,535, filed on Apr. 19, 2024, the entire content of which is incorporated herein by reference.

### FIELD

The present disclosure relates to hand tools, and more particularly to a ratchet with a swivel head.

### BACKGROUND

Hand-held ratchets for use with a removable socket are often arranged with the socket extending from the handle at a fixed angle of approximately 90 degrees. When using the ratchet in an area where access to the fastener to be driven is limited by surrounding components, such as the in the engine bay of an automobile (illustrated in FIG. 1), a user may have difficulty inserting the socket onto the fastener and turning the fastener. In some instances, use of a socket extension may not provide better access. Furthermore, use of socket extensions and/or a universal, or Cardan joint (e.g., a socket with a universal joint, illustrated in FIG. 2) to achieve better placement on the fastener may make it more difficult to consistently turn the fastener to the proper torque. Additionally, socket extensions and universal joints often have a longer, or higher profile.

### SUMMARY

The present disclosure provides, in one aspect, a ratchet including a ratchet head and a drive assembly supported by the ratchet head. The drive assembly includes a yoke rotationally supported in the ratchet head, a spline rotationally supported in the yoke, the spline rotatable about a spline rotation axis, and an anvil at least partially supported in the spline and rotatable with the spline, the anvil having an anvil rotation axis, the anvil rotation axis positionable at an angle relative to the spline rotation axis.

The present disclosure provides, in another aspect, a ratchet including: a ratchet head; an anvil at least partially supported in the ratchet head and rotatable relative thereto about a swivel axis between a minimum swivel angle and a maximum swivel angle; and a switch coupled to the ratchet head and the anvil, the switch is movable relative to the ratchet head to position the anvil at an angle between the minimum swivel angle and the maximum swivel angle.

The present disclosure provides, in another aspect, a ratchet including: a ratchet head; and a drive assembly supported by the ratchet head, the drive assembly including a yoke rotationally supported in the ratchet head, a spline rotationally supported in the yoke, the spline rotatable about a spline rotation axis, and an anvil at least partially supported in the spline for rotation with the spline as well as for rotation relative to the spline about a swivel axis, the anvil having an anvil rotation axis, the anvil rotation axis positionable at an angle relative to the spline rotation axis by rotation of the anvil about the swivel axis, and a bearing positioned between the anvil and the spline and permitting rotation about the swivel axis while coupling the anvil for rotation with the spline; and a switch coupled to the ratchet head and slidable relative thereto to rotate the anvil about the swivel axis.

Other features and aspects of the disclosure will become apparent by consideration of the following detailed description and accompanying drawings.

### BRIEF DESCRIPTION OF THE DRAWINGS

FIG. 1 is a side view of an embodiment of a fixed-axis ratchet used to drive a fastener.

FIG. 2 is a side view of an embodiment of ratchet with a universal joint socket.

FIG. 3 is a side of a ratchet of the present disclosure used to drive a fastener.

FIG. 4 is a perspective view of a ratchet head assembly.

FIG. 5 is a perspective view of a portion of the ratchet head assembly of FIG. 4.

FIG. 6 is a perspective view of a portion of the ratchet head assembly of FIG. 4, with a socket.

FIG. 7 is an exploded view of the ratchet head assembly of FIG. 4.

FIG. 8 is a section view of the ratchet head assembly of FIG. 4.

FIG. 9 is a perspective view of a spline of the ratchet head assembly of FIG. 4.

FIG. 10 is a perspective view of an anvil of the ratchet head assembly of FIG. 4 and a bearing coupled to the anvil.

FIG. 11 is a plan view of the spline, anvil, and bearing of the ratchet head assembly of FIG. 4.

FIG. 12 is a perspective view of a ratchet head assembly of FIG. 4, with the anvil positioned in an intermediate position.

FIG. 13 is a side view of the ratchet head assembly of FIG. 12.

FIG. 14 is a section view of the ratchet head assembly of FIG. 12.

FIG. 15 is a perspective view of the ratchet head assembly of FIG. 4, with the anvil positioned at a minimum swivel angle.

FIG. 16 is side view of the ratchet head assembly of FIG. 15.

FIG. 17 is a section view of the ratchet head assembly of FIG. 15.

FIG. 18 is a perspective view of the ratchet head assembly of FIG. 4, with the anvil positioned at a maximum swivel angle.

FIG. 19 is a side view of the ratchet head assembly of FIG. 18.

FIG. 20 is a section view of the ratchet head assembly of FIG. 18.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

Terms of approximation, such as “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

### DETAILED DESCRIPTION

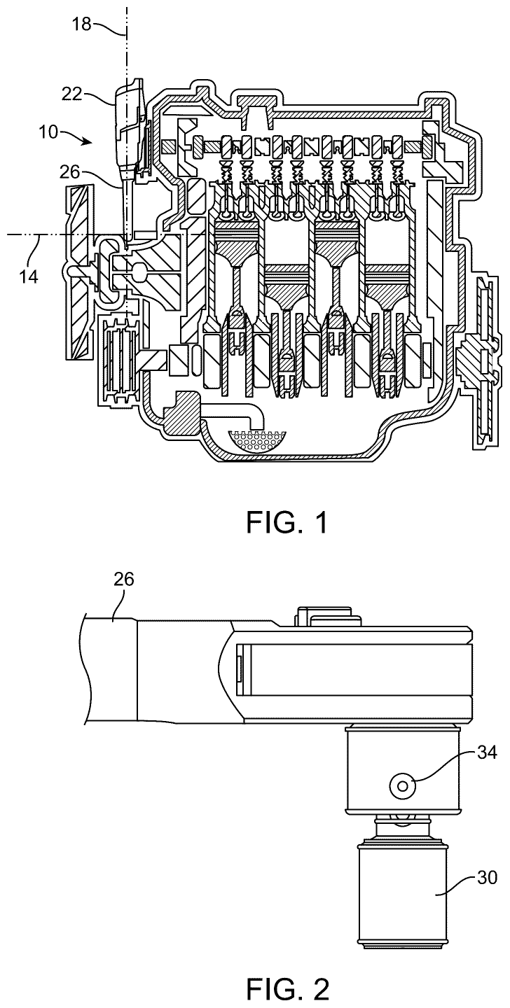

FIG. 1 illustrates a tool 10 (e.g., a ratchet) that is capable of rotating a fastener about an output axis 14 that extends at an approximately 90-degree angle from the tool axis 18 defined by the handle 22 and ratchet head 26 of the tool 10. FIG. 2 illustrates an embodiment of a socket 30 with a universal, or Cardan joint 34 coupled to the ratchet head 26.

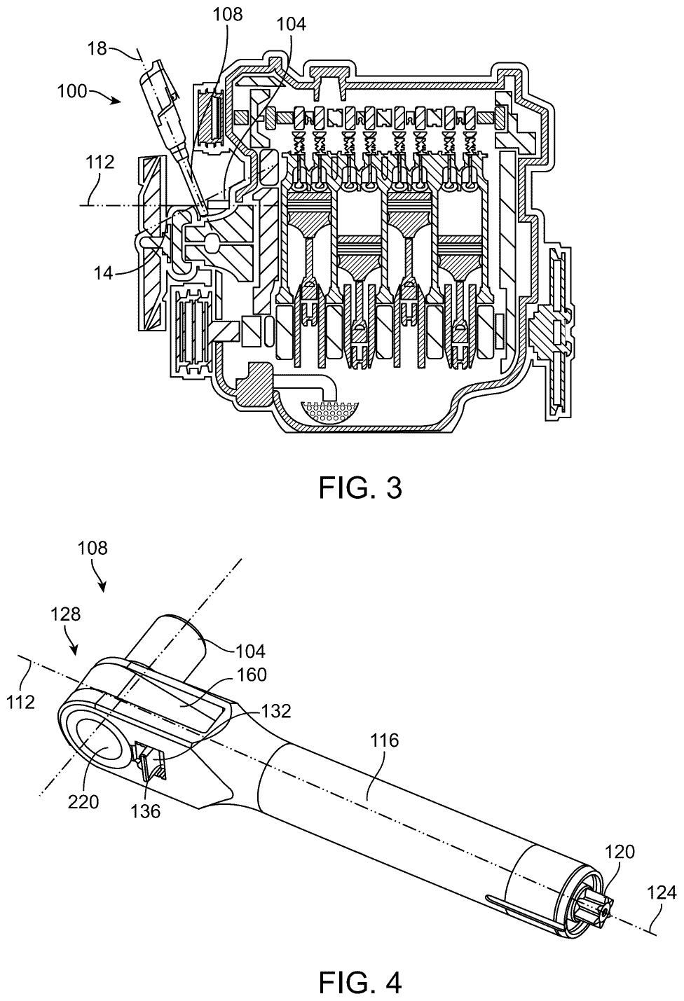

FIG. 3 illustrates a tool 100 according to the present disclosure. The tool 100 is illustrated as a battery-powered tool (e.g., a ratchet) to which a socket 104 or other output implement (e.g., Philips or flathead screwdriver bit, Allen key, Torx bit, etc.) configured to engage and drive a fastener may be removably coupled. While the remainder of the disclosure will refer to a socket, it should be understood that another of the output implements referenced above, or similar implements not listed may be used in place of a socket. In other embodiments, the tool 100 may instead be a manually operated too (i.e., hand-turned). The tool 100 includes a ratchet head assembly 108 that permits the socket 104 to be rotated within an angular range relative to the ratchet head assembly 108, as will be described in greater detail below, such that the rotational output of the socket 104 about a socket axis 112 can be positioned at an angle relative to the ratchet head assembly 108, in comparison to the rotational output axis 14 of the fixed-output ratchet 10 of FIG. 1. As illustrated in FIG. 3, the rotational output axis 14 is superimposed to illustrate the angle at which a fastener can be driven by the tool 100 of the present disclosure in comparison to other fixed-angle ratchets 10. It will be appreciated that positioning (i.e., rotation) of the socket axis 112 of FIG. 3 at a variable angular position in relation to the tool axis 18 allows a user to more easily access and engage a fastener in a confined area. It will also be appreciated that the tool 100 may have a smaller profile than the ratchet 10 of FIG. 1 with the socket 30 of FIG. 2, permitting access to fasteners with a smaller amount of space above the head of the fastener.

With reference to FIG. 4, a ratchet head assembly 108 of the tool 100 is illustrated. The ratchet head assembly 108 includes a ratchet head 116 that rotationally supports a crankshaft 120 (e.g., with bearings) extending through the ratchet head 116. The crankshaft 120 is rotatable about a drive axis 124 that may be coextensive with the tool axis 18 or may be parallel to and offset from the tool axis 18. The ratchet head assembly 108 also includes a drive assembly 128 that is supported in the ratchet head 116. The drive assembly 128 receives a rotational output about the drive axis 124 from the crankshaft 120 and converts the rotational output to rotation about the socket axis 112.

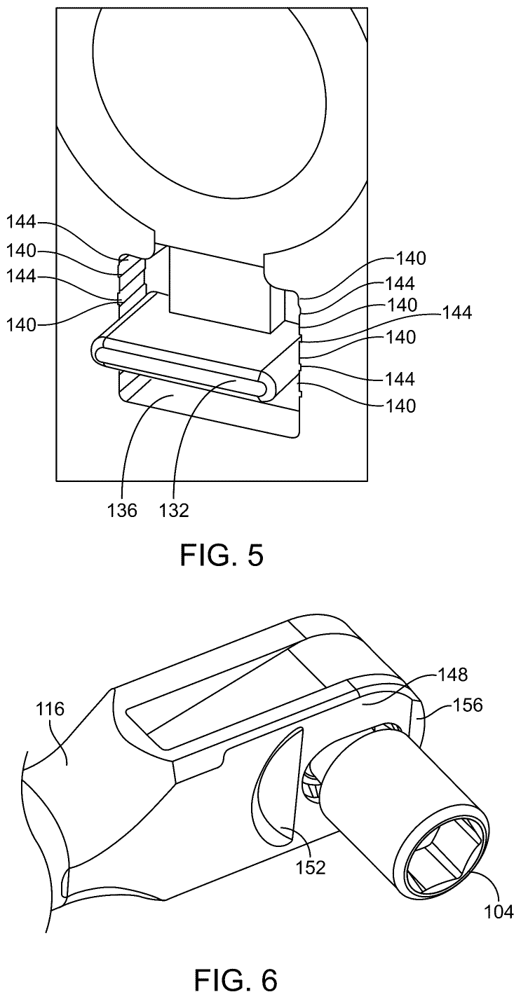

The ratchet head 116 supports a switch 132 that at least partially extends through a hole 136 in the ratchet head 116 and the edges of the switch 132 contact the edges of the hole 136. With reference to FIG. 5, the hole 136 includes pairs of ridges 140 extending inwardly into the hole 136 from opposites sides of the hole 136. The ridges 140 define pairs of recesses 144. The recesses 144 correspond to different angular positions of the socket 104 and the socket axis 112. As the switch 132 is translated between different pairs of recesses 144 corresponding to the different angular positions of the socket, the ridges 140 act as detents to maintain the switch 132 in the pair of recesses 144.

With reference to FIG. 6, the ratchet head 116 may define or more indents the extend inwardly from the generally flat face 148 of the ratchet head 116. The present embodiment includes a first indent 152 and a second indent 156 to accommodate a socket 104 that has been rotated to different angular positions. The first indent 152 has an arcuate profile. The second indent 156 is a chamfer of the edge of the ratchet head 116. The first and second indents 152, 156 may instead have another profile to accommodate another output implement.

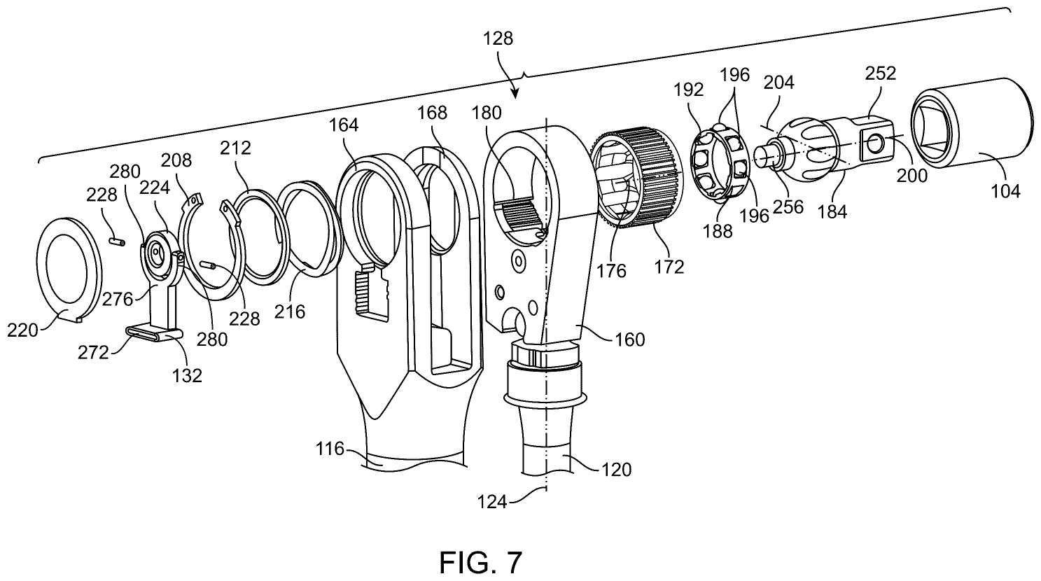

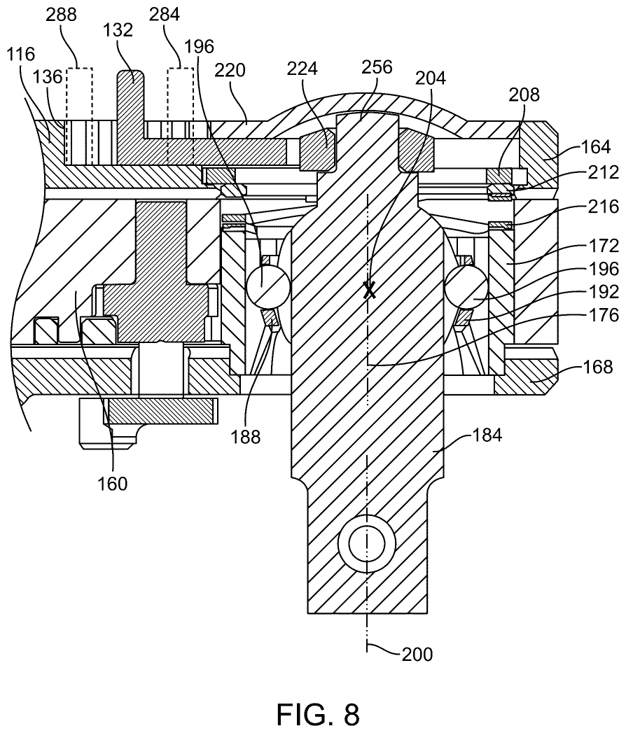

With reference to FIGS. 7 and 8, the drive assembly 128 includes a yoke 160 rotationally supported between upper and lower flanges 164, 168 of the ratchet head 116. The yoke 160 is coupled to and receives a rotational output from the crankshaft 120. The drive assembly 128 also includes a spline 172 supported in the yoke 160. The spline 172 is rotatable about a spline rotation axis 176 in response to engagement with a pawl 180 that is supported in the yoke 160 and configured to incrementally rotate the spline 172 in a user-selected direction about the spline rotation axis 176 (e.g., in a clockwise direction for tightening a fastener or in a counter-clockwise direction for loosening a fastener).

The drive assembly 128 also includes an anvil 184 supported in the spline 172 and a bearing 188 (e.g., a cage 192 supporting one or more balls 196, for instance, 8 balls, positioned equidistantly about the circumference of a portion of the anvil 184) positioned between the anvil 184 and the spline 172. The anvil 184 and bearing 188 are rotatable with spline 172, with rotation transferred from the spline 172 to the bearing 188 to the anvil 184. The anvil 184 is rotatable about an anvil rotation axis 200. The bearing 188 also supports rotation of the anvil 184 relative to the spline 172 about a swivel axis 204, which permits the anvil rotation axis 200 to be positioned at an angle relative to the spline rotation axis 176. A socket 104 is couplable to the anvil 184. The spline 172, anvil 184, and bearing 188 define a constant-velocity joint that transfers a rotational input about a first axis (e.g., the spline rotation axis 176) to a rotational output about a second axis (e.g., the anvil rotation axis 200) positioned at an angle relative to the first axis, while maintaining a constant velocity of the rotational output.

Retention elements (e.g., a lock ring 208, washer 212, and spring washer 216) are positioned in the ratchet head 116 and engage the spline 172 to maintain the spline 172 in position in the ratchet head 116. A cover 220 is also coupled to the ratchet head 116. The drive assembly also includes an annular bushing 224 coupled to the switch 132 by pins 228 (e.g., two pins) which permit rotation of the annular bushing 224 relative to the switch 132. The annular bushing 224 also engages the anvil 184 in a sliding fit, allowing rotation of the anvil 184 relative to the annular bushing 224.

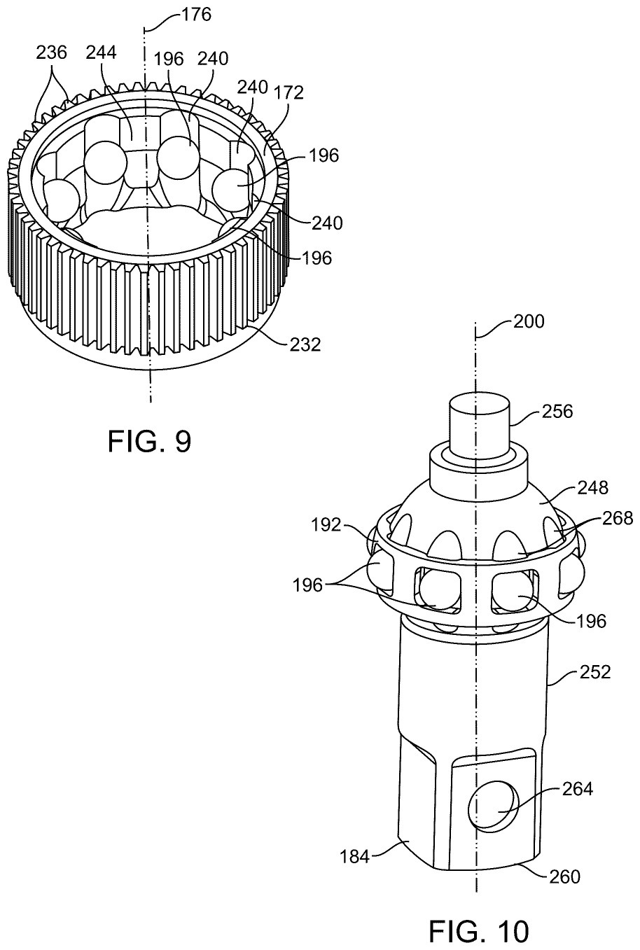

With reference to FIG. 9, the spline 172 has a ring-shaped body 232 with teeth 236 extending along the ring-shaped body 232 parallel to the spline rotation axis 176 that are engageable with the pawl 180 (FIG. 7). A plurality of arcuate grooves 240 extend along the inner face 244 of the ring-shaped body 232 and receive the one or more balls 196.

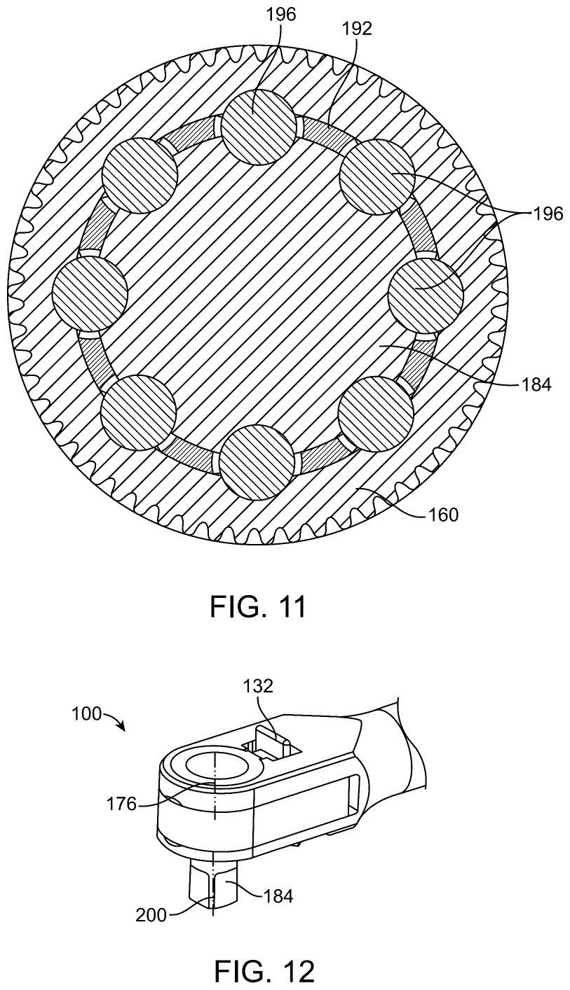

With reference to FIG. 10, the anvil 184 includes a coupling portion 248, a drive portion 252, and an adjustment portion 256. The coupling portion 248 has a spherical outer surface. The drive portion 252 and adjustment portion 256 extend from the spherical coupling portion 248 in opposite directions along the anvil rotation axis 200. The drive portion 252 has an end 260 with a square cross-section (e.g., a square with a width of ¼″, ⅜″, ½″, etc.) to which a socket is couplable and may include a detent 264 supported in the drive portion 252. The adjustment portion 256 has a generally cylindrical shape, although the adjustment portion 256 may instead have another profile. One or more arcuate grooves 268 (e.g., 8 grooves) corresponding to the number of balls 196 supported in the cage 192 are defined in the spherical coupling portion 248 and extend in a direction parallel to the anvil rotation axis 200. With reference to FIG. 11, the cage 192 is positioned between the spline 172 and the anvil 184 and circumferentially surrounds the spherical coupling portion 248. The balls 196 are supported by the cage 192 and spaced equidistantly about the circumference of the spherical coupling portion 248.

Returning to FIG. 7, the switch includes an engagement portion 272 that is engageable by a user and a coupling portion 276 that extends from the engagement portion 272. The coupling portion 276 includes arms 280 that have an arcuate, or C-shaped profile that is coupled to the annular bushing 224 that is positioned to circumferentially surround the adjustment portion 256 of the anvil 184.

With continued reference to FIGS. 7 and 8, the drive assembly is configured to change the rotational direction of the tool output from rotation about the drive axis 124 to a rotation about a spline rotation axis 176 that is positioned at approximately 90 degrees relative to the drive axis 124, which in turn is transferred from the spline 172 to the anvil 184 by the one or more balls 196 positioned in the cage 192. As the crankshaft 120 is rotated about the drive axis 124, engagement of the end of the crankshaft 120 (e.g., by a spherical bushing) with the yoke 160 rotates the yoke 160 about the spline rotation axis 176. Rotation of the yoke 160 along with the pawl 180 supported in the yoke 160 engage the spline 172 to incrementally rotate the spline 172. Engagement of the spline 172 with the anvil 184 (via the bearing 188) transfers rotation of the crankshaft 120 to the anvil 184.

With reference to FIG. 8, the switch 132 is movable (e.g., slidable) between first and second positions 284, 288 (illustrated schematically) that correspond to the minimum and maximum swivel angles of the anvil 184, which are defined by and correspond to the detents (ridges 140). The first and second positions 284, 288 are defined by the recesses 144 (FIG. 5). The swivel angle defines the angle of the anvil rotation axis 200 relative to the spline rotation axis 176. One or more positions (e.g., the illustrated position of the switch 132 in FIG. 8) may be defined between the first and second positions 284, 288. The positions at which the switch 132 is positionable correspond to different swivel angles and are spaced evenly between the minimum swivel angle and maximum swivel angle. The tool 100 of the present disclosure has minimum and maximum swivel angles of −20 degrees and 20 degrees and switch positions that correspond with 10-degree increments between the minimum and maximum swivel angles. That is, the anvil 184 is positionable at swivel angles of −20 degrees, −10 degrees, 0 degrees, 10 degrees, and 20 degrees. In other embodiments, the anvil 184 may be positionable at angles that correspond with different minimum and maximum swivel angles (e.g., 15 degrees, 30 degrees, 45 degrees, etc.) and/or different angular increments (e.g., 5 degrees, 15 degrees, etc.).

To change between different swivel angles, the user engages the engagement portion 272 of the switch 132 and moves the switch 132 to another position. The arms 280 of the switch 132, coupled to the annular bushing 224 by the pins 228, move the annular bushing 224. The annular bushing 224 is positioned to circumferentially surround the adjustment portion 256 of the anvil 184, which then pivots about the swivel axis 204, changing the swivel angle.

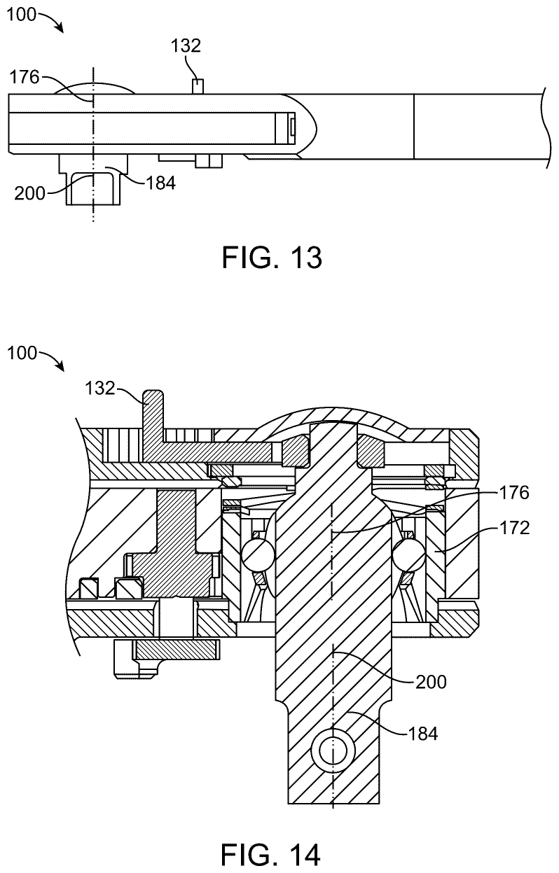

With reference to FIGS. 12-14, the tool 100 is shown with the anvil 184 positioned at a swivel angle of 0 degrees. The switch 132 is positioned at approximately the midpoint between the first position 284 and second position 288 and the spline rotation axis 176 is aligned with the anvil rotation axis 200.

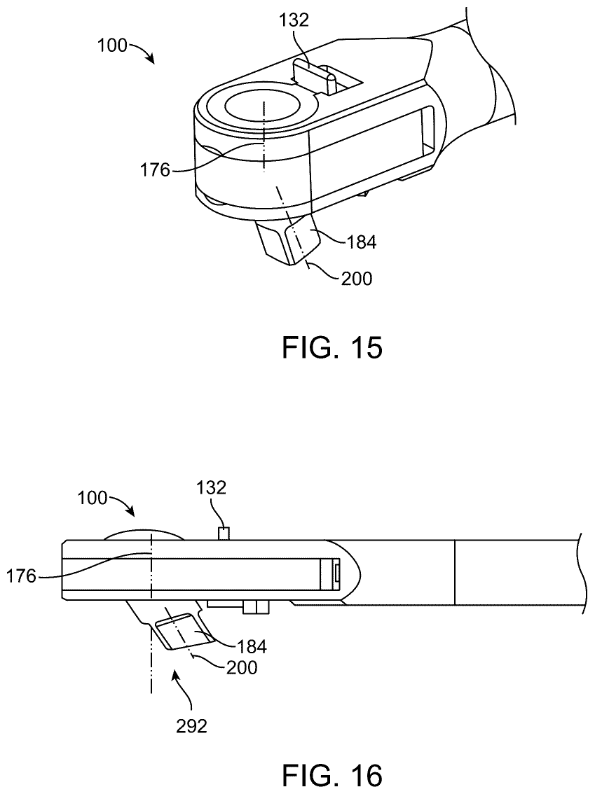

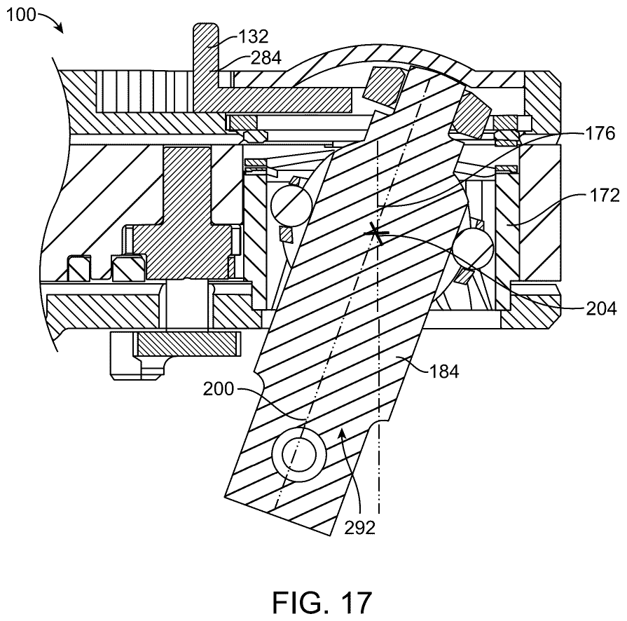

With reference to FIGS. 15-17, the tool 100 is shown with the switch 132 positioned at the first position 284 and the anvil 184 positioned at the minimum swivel angle 292 (e.g., −20 degrees). The anvil rotation axis 200 is positioned at the minimum swivel angle 292 by rotation of the anvil 184 about the swivel axis 204 in response to movement of the switch 132 to the first position 284.

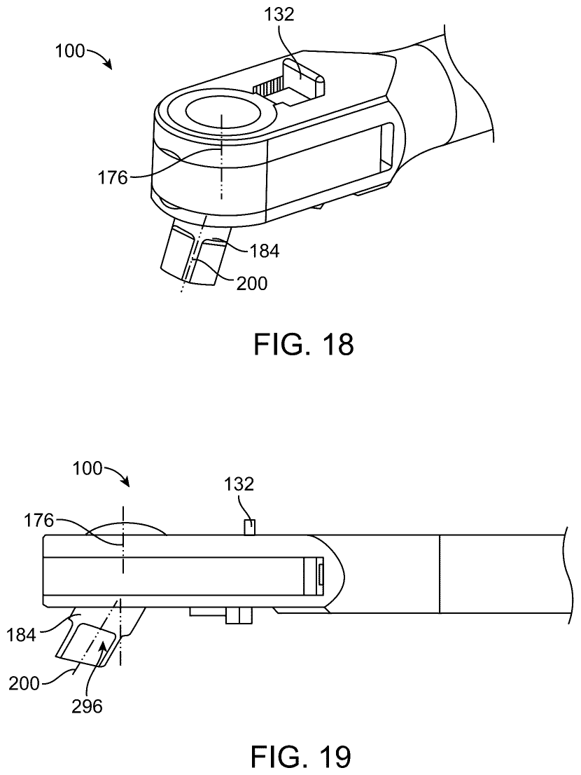

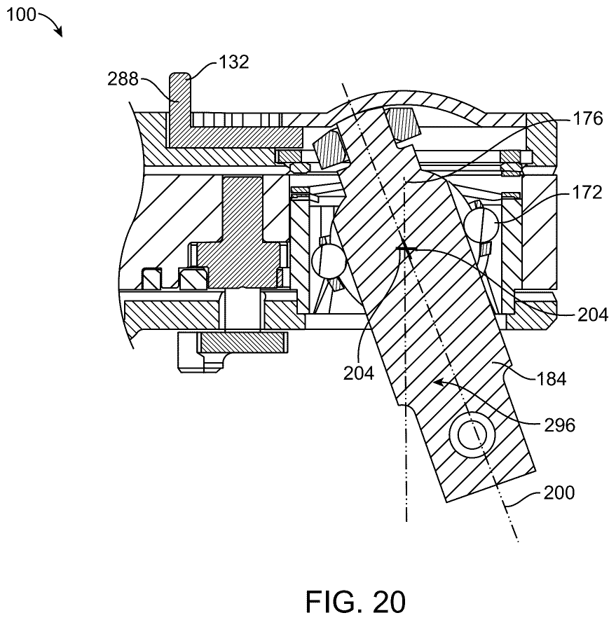

With reference to FIGS. 18-20, the tool 100 is shown with the switch 132 positioned at the second position 288 and the anvil 184 positioned at the maximum swivel angle 296 (e.g., 20 degrees). The anvil rotation axis 200 is positioned at the maximum swivel angle 296 by rotation of the anvil 184 about the swivel axis 204 in response to movement of the switch 132 to the second position 288.

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A ratchet comprising:
a ratchet head; and
a drive assembly supported by the ratchet head, the drive assembly including
a yoke rotationally supported in the ratchet head,
a spline rotationally supported in the yoke, the spline rotatable about a spline rotation axis, and
an anvil at least partially supported in the spline and rotatable with the spline, the anvil having an anvil rotation axis, the anvil rotation axis positionable at an angle relative to the spline rotation axis.

2. The ratchet of claim 1, wherein the angle is within a range of −20 degrees and 20 degrees.

3. The ratchet of claim 1, wherein the anvil includes a coupling portion from which a drive portion extends, the drive assembly further including a bearing positioned between the anvil and the spline.

4. The ratchet of claim 3, wherein the bearing includes a cage and a plurality of balls, the cage positioned about the coupling portion between the anvil and the spline, and the plurality of balls are supported by the cage and spaced about the coupling portion.

5. The ratchet of claim 3, wherein the coupling portion has a spherical outer surface.

6. The ratchet of claim 4, wherein the coupling portion defines a plurality of grooves corresponding to the plurality of balls, the grooves extending in a direction parallel to the anvil rotation axis.

7. The ratchet of claim 6, wherein the grooves are spaced equidistantly about the coupling portion.

8. The ratchet of claim 3, wherein the anvil includes an adjustment portion extending from the coupling portion, the ratchet further comprising a switch that is movable between a first position and a second position, the switch is supported by the ratchet head and is coupled to the adjustment portion, the first position and the second position corresponding to a maximum angle and a minimum angle.

9. The ratchet of claim 8, wherein the switch includes an engagement portion from which a coupling portion extends, the coupling portion including a first arm and a second arm coupled to a bushing that circumferentially surrounds the adjustment portion.

10. The ratchet of claim 9, wherein the ratchet head defines a plurality of detents corresponding to at least the maximum angle and the minimum angle.

11. The ratchet of claim 1, wherein the ratchet head includes a recess configured to accommodate a socket that is removably couplable to the anvil.

12. A ratchet comprising:
a ratchet head;
an anvil at least partially supported in the ratchet head and rotatable relative thereto about a swivel axis between a minimum swivel angle and a maximum swivel angle; and
a switch coupled to the ratchet head and the anvil, the switch is movable relative to the ratchet head to position the anvil at an angle between the minimum swivel angle and the maximum swivel angle.

13. The ratchet of claim 12, wherein the switch is slidable relative to the ratchet head.

14. The ratchet of claim 12, wherein the anvil includes an adjustment portion extending from a coupling portion coupled to the ratchet head, and the switch is coupled to the adjustment portion.

15. The ratchet of claim 14, wherein the switch includes a bushing coupled to the adjustment portion, the bushing permitting rotation of the anvil relative to the switch.

16. The ratchet of claim 15, wherein the switch includes a coupling portion including a first arm and a second arm coupled to the bushing.

17. The ratchet of claim 16, wherein the bushing is coupled to the first arm and the second arm by pins, permitting rotation of the bushing relative to the first arm and the second arm.

18. The ratchet of claim 12, wherein the ratchet head defines a plurality of detents engageable with the switch.

19. The ratchet of claim 12, wherein angle is within a range of −20 degrees and 20 degrees.

20. A ratchet comprising:
a ratchet head; and
a drive assembly supported by the ratchet head, the drive assembly including
a yoke rotationally supported in the ratchet head,
a spline rotationally supported in the yoke, the spline rotatable about a spline rotation axis, and
an anvil at least partially supported in the spline for rotation with the spline as well as for rotation relative to the spline about a swivel axis, the anvil having an anvil rotation axis, the anvil rotation axis positionable at an angle relative to the spline rotation axis by rotation of the anvil about the swivel axis, and
a bearing positioned between the anvil and the spline and permitting rotation about the swivel axis while coupling the anvil for rotation with the spline; and
a switch coupled to the ratchet head and slidable relative thereto to rotate the anvil about the swivel axis.
